(19) United States
(12) Patent Application Publication
(10) Pub. No.: US 2003/0220983 A1
(43) Pub. Date: Nov. 27, 2003

(54) Method, system, and program for requesting objects to download over a network

(76) Inventor: Waikwan Hui, Fremont, CA (US)

Correspondence Address: KONRAD RAYNES VICTOR & MANN, LLP, 315 SOUTH BEVERLY DRIVE, SUITE 210, BEVERLY HILLS, CA, 90212, US

(21) Appl. No.: 10/155,721

(22) Filed: May 24, 2002

(51) Int. Cl. G06F 15/16

(52) U.S. Cl. 709/219

(57) ABSTRACT

Provided are a method, system, and program for processing a request to download an object from a client computer over a network. A request is received from the client and a determination is made as whether at least one object indicated in the request is available for download to the client computer, wherein the request is capable of indicating a plurality of objects to download. A determination is made as to whether the request indicates at least one precondition that applies to at least one of the objects indicated in the request and a determination is made as to whether the at least one available requested object to which the at least one precondition applies satisfies the precondition. A response is prepared including at least one available requested object if the precondition is satisfied and information is prepared indicating results of processing the request to return.

### BACKGROUND OF THE INVENTION

1. Field of the Invention

The present invention relates to a method, system, and program for requesting objects to download over a network.

2. Description of the Related Art

Prior art techniques for downloading software include user initiated software downloads and application program downloads initiated by application code. In the user initiated type of download, a computer user will interactively access an electronic site over a network, such as an Internet web site, an electronic bulletin board, File Transfer Protocol (FTP) site, etc., and search for available software, such as updates, patches or new programs. The user would then review the available downloads, select a program to download, and then download and install the selected program.

In the automatic download technique, an application program may automatically search for updates or patches periodically by querying a specific Universal Resource Locator (URL) address over the network. This automatic download technique requires that the application access a predetermined site where updates are maintained and available for download. The application may then decide whether to download depending on the programs available at the download site and whether they are suitable for the application.

Notwithstanding the above discussed download prior art, there is a need in the art for improved techniques for allowing client systems to communicate download requests to the server concerning objects to download from the server over the network.

### SUMMARY OF THE PREFERRED EMBODIMENTS

Provided are a method, system, and program for processing a request to download an object from a client computer over a network. A request is received from the client and a determination is made as whether at least one object indicated in the request is available for download to the client computer, wherein the request is capable of indicating a plurality of objects to download. A determination is made as to whether the request indicates at least one precondition that applies to at least one of the objects indicated in the request and a determination is made as to whether the at least one available requested object to which the at least one precondition applies satisfies the precondition. A response is prepared including at least one available requested object if the precondition is satisfied and information is prepared indicating results of processing the request to return.

In further implementations, one precondition indicates a version of at least one requested object, and the at least one requested object satisfies the precondition if the at least one available requested object is the version indicated in the precondition.

Yet further, the information indicating results of processing the request includes information on each requested object that is included in the response and information on each requested object that is not included in the response.

Still further, the information on each requested object that is not included in the response includes an error code for the at least one requested object indicating a reason for the error and the at least one precondition that was not satisfied.

In still further implementations, the information indicating results of processing the request includes information indicating an overall result of processing all the at least one requested object and the precondition.

Further provided are a method, system, and program for generating a request to download an object from a server over a network. A request is generated indicating at least one object to download from the server, wherein the request is capable of indicating a plurality of objects to download. At least one precondition is provided that applies to at least one of the objects indicated in the request. The request and precondition are transmitted to the server and in response to the request and precondition, a response is received from the server including at least one available requested object if the precondition is satisfied and information indicating results of processing the request.

Described implementations provide techniques to allow a client and server to communicate concerning download object requests.

### BRIEF DESCRIPTION OF THE DRAWINGS

Referring now to the drawings in which like reference numbers represent corresponding parts throughout:

FIG. 1 illustrates a computing environment in which aspects of the invention are implemented;

FIG. 2 illustrates information to include in a response body to a download file request in accordance with implementations of the invention;

FIGS. 3a and 3b illustrate logic to process a download file request in accordance with implementations of the invention;

FIG. 4 illustrates logic to generate a download file request in accordance with implementations of the invention; and

FIG. 5 illustrates a computer architecture which may be utilized with certain implementations of the invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

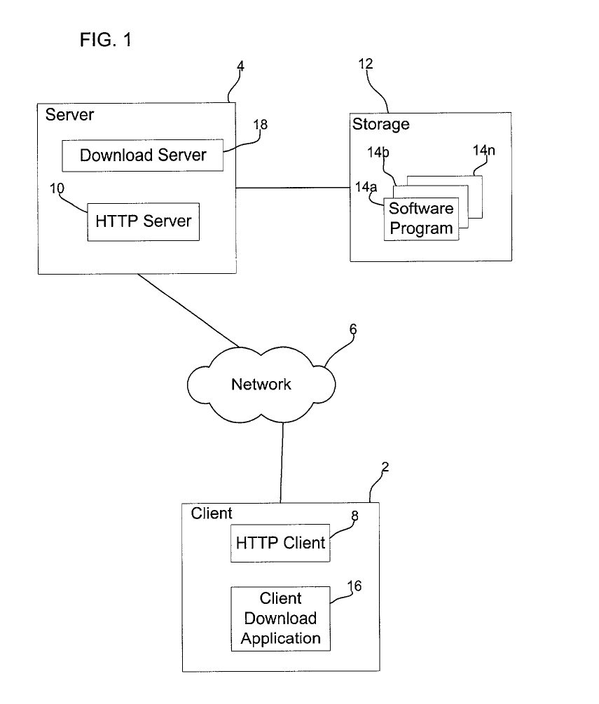

FIG. 1 illustrates a network computing environment in which aspects of the invention are implemented. A client computer 2 and server 4 communicate over a network 6, where the network may comprise any network known in the art (e.g., the Internet, an Intranet, a Wide Area Network (WAN), Local Area Network (LAN), Storage Area Network (SAN), etc.) using any network communication protocol (e.g., TCP/IP, Fibre Channel, Ethernet, Infiniband, etc.). The client 2 includes a Hypertext Transfer Protocol (HTTP) client 8 program to enable communication with an HTTP server 10 in the server 4. The server 4 includes a storage 12 including download software programs 14a, 14b . . . 14n, which may comprise application programs, updates, patches, fixes, etc. The storage 12 may comprise any non-volatile storage device known in the art, such as a hard disk drive, magnetic tape, optical disk, a Just a Bunch of Disks (JBOD), Direct Access Storage Device (DASD), Redundant Array of Independent Disks (RAID) server, storage subsystem, etc. The client 2 includes a client download application 16 that may issue commands in accordance with the described implementations to request the download software programs 14a, 14b . . . 14n. A download server 18 running in the server 4 would process the download requests from the client download application 16 to provide the client 2 access to the download software programs 14a, 14b . . . 14n.

The client 2 and server 4 may comprise any computational device known in the art, such as a workstation, personal computer, server, laptop, hand held computer, telephony device, network appliance, etc. Further, although certain described implementations utilize the HTTP protocol, in alternative implementations, any communication protocol known in the art may be used, including secure communication protocols such as the Secure Socket Layer (HTTPs). Further, there may be multiple client systems capable of communicating with the server 4 over the network 6 that include the components and capabilities described with respect to the client 2.

In certain implementations, the client download application 16 utilizes a download protocol to communicate requests for download software programs 14a, 14b . . . 14n to the download server 18, where the download server 18 is capable of processing the requests and returning information and/or the requested download software programs 14a, 14b . . . 14n to the requesting client download application 16 on the client 2. In certain implementations, the client download application 16 requests to the server 4 are submitted using the HTTP POST request. The HTTP POST method is used to request that the server 4 accept the entity enclosed, which would include the application download commands described herein.

Below is an example of the syntax of commands that the client download application 16 would submit to request software programs 14a, 14b . . . 14n to download over the network 6:

URL: The URL specified in the HTTP POST request is the URL of the download server 18 to invoke the download server 18 to interpret and process the download syntax.

action=downloadSW: Requests the download server 18 to take a particular download action. The request may also specify a version number with the name of the application

maxSize: places a file size constraint on any download software programs 14a, 14b . . . 14n satisfying the name and version constraints to download. This field is optional.

Following is an example of an HTTP POST request (1) utilizing the above application download command syntax:

POST/softwareServerURL HTTP/1.0 action=downloadSW&maxSize=31457280&swName=Program1-2.1& swName=Program2-1.0&swName=Program3-1.21 (1)

In the above download request (1), the request is directed to a download program URL and the action requests to download Program1, version 2.1, Program 2, version 1.0, and Program3, version 1.21, and specifies a maximum size of the download of 30 megabytes (Mb). The ampersand (“&”) is used to delineate a separation between download commands.

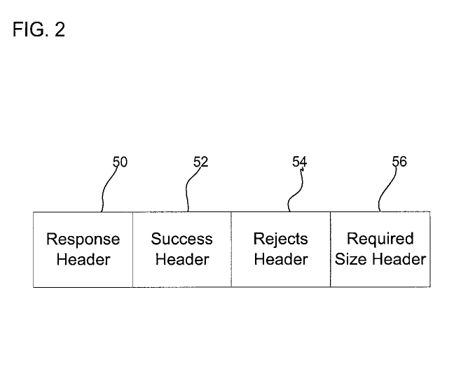

In responding to a download request, the download server 18 would return information on the client download application 16 request. FIG. 2 illustrates the fields in the response body, which may be implemented as HTTP headers. A response header 50 would provide one of the following response codes providing information on the overall status of processing all the requested programs:

OK: indicates that the client request was successful and that the download server 18 response includes the requested download program(s) 14a, 14b . . . 14n.

Partial: indicates that the client request was only partially fulfilled, such as the case if less than all of the requested programs are included in the response.

Bad Request: The download server 18 could not understand the request, likely due to a syntax error.

Forbidden: The request was understood, but the download server 18 is unwilling to fulfill the request. This may occur if the download software programs 14a, 14b . . . 14n that satisfy the name and version specified with the request do not satisfy the size constraint specified with the maxSize parameter. This may also occur if the download server 18 cannot successfully authenticate the download request, should the server perform authentication.

Not Found: the requested resource was not found or is not available.

Internal Server Error: An unexpected error occurred inside the server 4 that prevented the server 4 from fulfilling the request.

A success header 52 includes the name of all successfully downloaded requested files along with the file size of each successfully downloaded file. A rejects header 54 provides a list of all requested programs that were not successfully downloaded as well as one of the following status codes indicating the reason for the failure of downloading that particular program:

Successfully downloaded: Indicates that the requested download program is available and included in the download.

Unexpected error: indicates that an unexpected error was encountered while trying to access the requested download program 14a, 14b . . . 14n.

Does Not Exist: the requested download program 14a, 14b . . . 14n does not exist in storage 12.

Duplicate request: indicates that the requested download file 14a, 14b . . . 14n was already processed and considered.

A required size header 56 provides a list of all the files if the cumulative file size of all the requested files that are available for download exceeds the specified maxSize parameter. The required size header 56 includes the file size of each of the requested files. Additional information may be included in the response body. Additionally, information described as included in specific headers may be combined into fewer headers or distributed in more than the described number of headers.

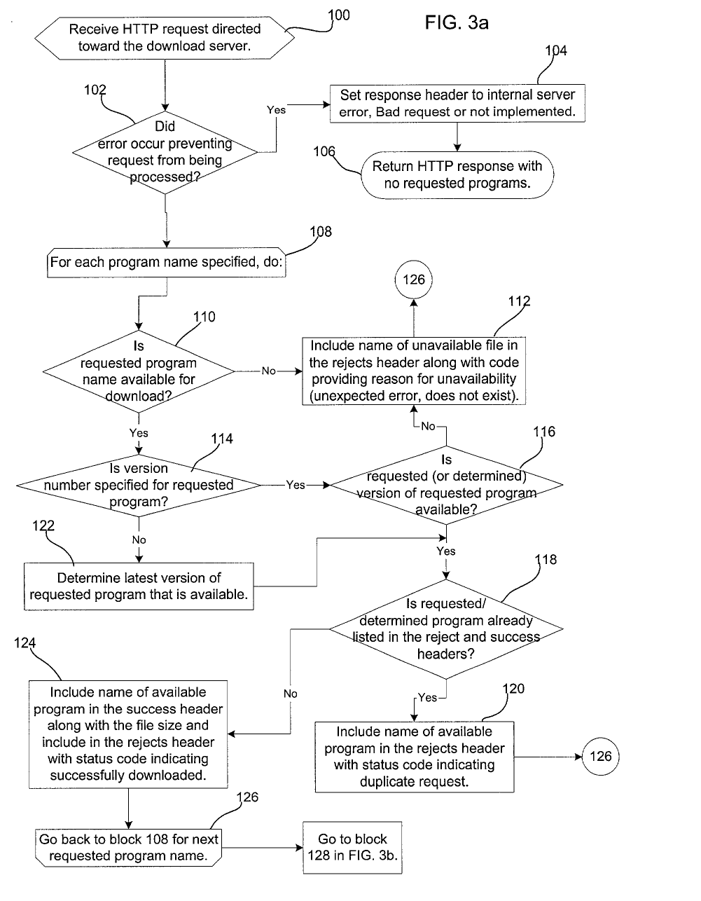

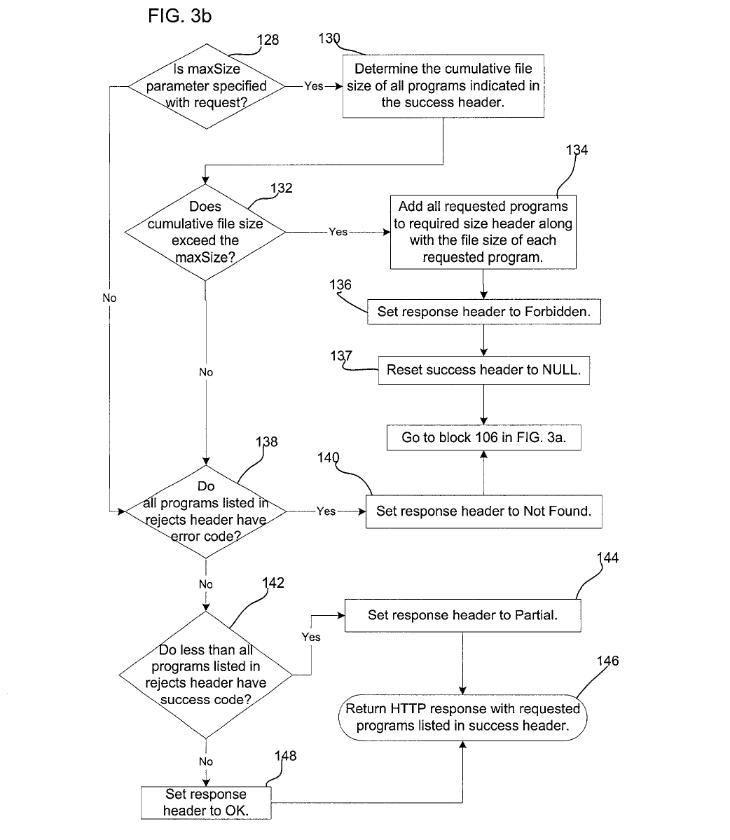

FIGS. 3a and 3b illustrate logic implemented in the download server 18 to handle HTTP requests conforming to the download syntax from the client download application 16. Control begins with the download server 18 receiving (at block 100) an HTTP Post request directed to the URL of the download server 18. If (at block 102) the download server 18 experiences an error that interferes with processing the request, at anytime while processing the request, then the download server 18 sets (at block 104) the response header 52 to indicate the cause of the error, such as an internal server error, bad request syntax, functionality not implemented, etc. The response including the header with filled-in information is then returned (at block 106) to the requesting client download application 16. The download server 18 performs a loop at blocks 108 to 126 for each program requested in the received HTTP request. If (at block 110) the requested program is not available, i.e., is not included in the storage 12 maintaining download software programs 14a, 14b . . . 14n, then the download server 18 adds (at block 112) the name of the requested file to the rejects header 54 along with the code providing the reason for the lack of availability, e.g., unexpected error, does not exist, etc. Control then proceeds to block 126 to consider a next requested program in the received HTTP request.

If (at block 110) the requested program is available and if (at block 114) a version number is specified in the received HTTP request for the requested program and if (at block 116) the requested version of the program 14a, 14b . . . 14n is not available in the storage 12 used by the server 4, then control proceeds to block 112 to include the name of the unavailable file in the rejects header 54 (FIG. 2). If (at block 116) the requested file and version is available and if (at block 118) the requested program is already listed in the success 52 header, then the program has already been considered and the download server 18 includes (at block 120) the name of the available program in the rejects header 54 with the status code indicating that the request is a duplicate of a previously considered request. Control then proceeds to block 126 to consider the next requested program indicated in the HTTP request, if there are further requested programs not yet considered. If (at block 114) a version was not specified for the requested program, then the download server program 18 determines (at block 122) the latest available version of the requested program 14a, 14b . . . 14n in the storage 12 and proceeds to block 118 to consider whether determined latest version has already been processed. If (at block 118) the requested or determined program 14a, 14b . . . 14n has not been previously considered, then the download server 18 includes (at block 124) the name of the available program in the success header 52 along with the file size and includes in the rejects header 54 the name of the program and version with status code indicating successfully downloaded.

After considering all programs specified in the download request received at block 100, control proceeds to block 128 in FIG. 3b where the download server 18 determines whether a maxSize parameter is specified. If so, then the download server 18 determines (at block 130) the cumulative file size of all programs indicated in the success header 52, i.e., all requested programs that may be downloaded. If (at block 132) the determined cumulative file size exceeds the maxSize, then the name of all the requested programs are added (at block 134) to the required size header 56 along with the file size of each program and the response header 50 is set (at block 136) to “forbidden”, indicating that not enough space was provided to download all the requested programs that are available. Information on the maxSize that was exceeded may also be included in the headers. Also, the success header is set (at block 137) to NULL, indicating that the requested operation failed. Control then proceeds to block 106 in FIG. 3a to return the HTTP request with the headers with none of the requested programs.

If the cumulative file size does not exceed the specified maxSize parameter (at block 132) or if no maxSize parameter is specified (at block 128), then the download server 18 determines (at block 138) whether all programs indicated in the rejects header 54 have an error code, such as “unexpected error” or “does not exist”. If so, then the response header 50 is set (at block 140) to “not found” and control proceeds to block 106 in FIG. 3a to return the response with the filled-in header information. If (at block 138) some of the programs are available for download, as indicated in the rejects header 54 or success header 52, then the download server 18 determines (at block 142) whether less than all the programs in the rejects header 54 have the success code. If so, then the download server 18 sets (at block 144) the response header 50 to “partial” and returns (at block 146) an HTTP response to the received request with all the filled-in header information and requested downloads that are available, i.e., all the requested files indicated in the success header 52. If (at block 142) all the requested programs indicated in the rejects header have the success code, i.e., every requested program is available for download from the storage 12, then the download server 18 sets (at block 148) the response header 50 to “OK” and proceeds to block 146 to return the response with all the requested programs.

Thus, the logic of FIGS. 3a and 3b provide a program to handle a download request syntax specifying specific programs to download, regardless of the nature or use of those programs.

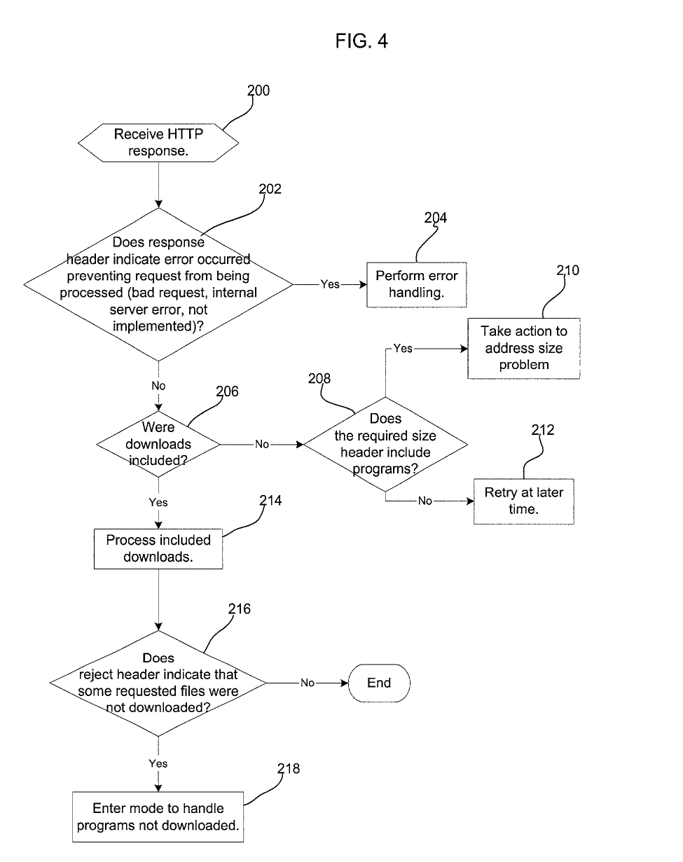

FIG. 4 provides an example of operations the client download application 16 may perform to handle possible responses to the download request from the download server 18. Control begins at block 200 with the client 2 receiving an HTTP response to the HTTP POST request using the download syntax discussed above and processed by the download server 18 according to the logic of FIGS. 3a and 3b. The HTTP client 8 would forward the response to the client download application 16. If (at block 202) the response header 50 indicates that an error occurred preventing the request from being processed, such as a bad request syntax, internal server error, not implemented, etc., then the client download application 16 enters an error handling mode (at block 204) to deal with the error and possibly resubmit the request in proper syntax or to an available download server 18 at a later time. Otherwise, if (at block 206) download programs were not included with the received response, then the client download application 16 determines (at block 208) whether the required size header 56 lists programs. If so, then the client download application 16 performs (at block 210) actions to address the size problem. For instance, the client download application 16 may resubmit the request for the programs to the download server 18 without a maxSize parameter, or with a larger maxSize value. Otherwise, if there was no maxSize parameter specified, then the download failed due to problems at the server 4. In such case, the client download application 16 may retry (at block 212) the request for the programs at a later time.

If (at block 206) downloads were included in the received HTTP response, then the client download application 16 processes (at block 214) the included downloads, where such processing may comprise installing the downloads, storing them, forwarding the downloads to another location, or any other processing of the included downloads. If (at block 216) the rejects header 54 indicates that some of the requested programs were not downloaded, then the client download application 16 enters a mode (at block 218) to handle those requested programs that were not downloaded. The client may decide to resubmit the request at a later time or perform some other action with respect to those files not downloaded.

The described implementations thus provide a download request syntax and protocol that a client may use to request any type of program and file from a server that includes the proper interpreter or download server 18 capable of processing such requests, and the associated preconditions for the request, e.g., file size, operating system platform, etc. The described implementations further provide a response protocol for the download server 18 to use to communicate information on the result of processing the client download request and the required constraints. The client download application 16 may use the response codes received by the download server 18 to provide a more intelligent response to the download request that is based on consideration of specific result information.

### Additional Implementation Details

The described download request protocol and operations may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In the described implementations, the download request commands and responses were embedded in HTTP commands. In alternative implementations, the download requests and response syntax may be submitted with any communication protocol known in the art and is not limited to HTTP. Moreover, the download request commands and responses may be submitted with a secure transport protocol, such as secure HTTP (HTTPS, better known as Secure Socket Layer), or any other secure transport protocol known in the art to authenticate and verify the authority the download application 16 has with respect to the requested programs or files.

In the described implementations, the components downloaded are software programs. However, the download request and response protocol may be used to download any object or file, and is not limited to requesting the download of programs.

In the described implementations, the download request syntax allowed the client to specify a maximum download file size and version name for files to download. The download request syntax may allow for additional factors to be checked when the server determines whether requested programs are available for download, such as the operating system platform on which the requested program will run, or any other quantifiable factor known in the art.

In the described implementations, the preconditions submitted with the requests, such as version number, file size, etc., were included with the request transmission. In alternative implementations, the preconditions may be transmitted separately from the file request. In the described implementations, the response included both any available requested files and information on the processing of the request included in the response header. Alternatively, the requested files and response header may be transmitted separately.

The illustrated logic of FIGS. 3a, 3b and 4 shows certain events occurring in a certain order. In alternative implementations, certain operations may be performed in a different order, modified or removed. Morever, steps may be added to the above described logic and still conform to the described implementations. Further, operations described herein may occur sequentially or certain operations may be processed in parallel. Yet further, operations may be performed by a single processing unit or by distributed processing units.

The download server 4 may be deployed by a software vendor to provide updates, upgrades, fixes and patches to vendor software. Alternatively, the download server 4 may be deployed by an Internet software store where users may purchase and download applications or any electronic media files, such as multi-media content, e.g., music files, video, text, etc. The client download application 16 code may be a standalone program that downloads specified programs, or alternatively be included within an application program to automatically check for updates, fixes, patches, etc. to an application installed on the client 2.

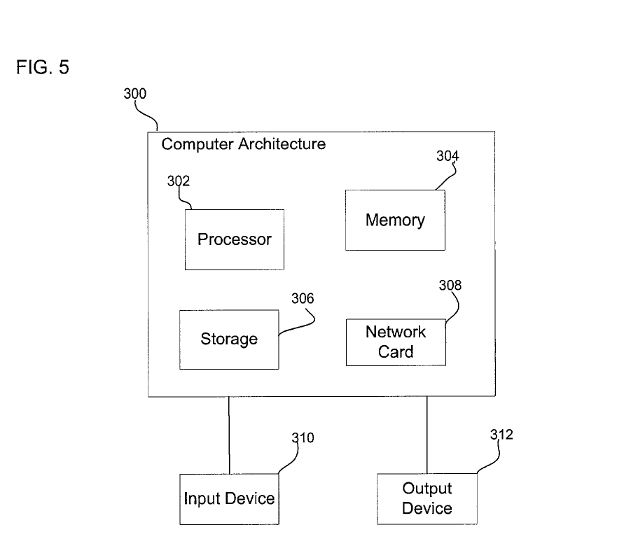

FIG. 5 illustrates one implementation of a computer architecture 300 of the client 2 and server 4 systems. The computer architecture 300 may include a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes a network card 308 to enable communication with a network. An input device 310 is used to provide user input to the processor 302, and may include a keyboard, mouse, pen-stylus, microphone, touch sensitive display screen, or any other activation or input mechanism known in the art. An output device 312 is capable of rendering information transmitted from the processor 302, or other component, such as a display monitor, printer, storage, etc.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for processing a request to download an object from a client computer over a network, comprising:
receiving a request from the client;
determining whether at least one object indicated in the request is available for download to the client computer, wherein the request is capable of indicating a plurality of objects to download;
determining whether the request indicates at least one precondition that applies to at least one of the objects indicated in the request;
determining whether the at least one requested object satisfies the at least one precondition;
preparing a response including at least one available requested object if the at least one precondition is satisfied; and
preparing information indicating results of processing the request to return with the response.

2. The method of claim 1, wherein one precondition indicates a version of at least one requested object, wherein the at least one requested object satisfies the precondition if the at least one requested object is the version indicated in the precondition.

3. The method of claim 2, further comprising:
including a highest version of the at least one available requested object in the response when one precondition does not indicate a version for the at least one requested object.

4. The method of claim 1, wherein one precondition indicates a maximum object size that applies to all the requested objects, further comprising:
determining whether a cumulative object size of the available requested objects exceeds the maximum object size, wherein the at least one available requested object satisfies the precondition if the cumulative object size is less than or equal to the available requested object size.

5. The method of claim 4, wherein the information indicating results of processing the request includes:
information on the at least one requested object and a size of the at least one requested object when the cumulative object size exceeds the maximum object size.

6. The method of claim 1, wherein the information indicating results of processing the request includes:
information on each requested object that is included in the response;
information on each requested object that is not included in the response.

7. The method of claim 6, wherein the information on each requested object that is not included in the response includes an error code for the at least one requested object indicating a reason for the error and the precondition that was not satisfied.

8. The method of claim 7, wherein the error code is a member of a set of error codes indicating:
that an unexpected error occurred while accessing the requested object;
that the requested object does not exist; and
that the requested object was previously indicated in the request.

9. The method of claim 1, wherein the information indicating results of processing the request includes:
information indicating an overall result of processing all the at least one requested object and the precondition.

10. The method of claim 9, wherein the information indicating an overall result of processing all the at least one requested object indicates at least one of:
that all the requested objects are included with the response;
that less than all the requested objects are included in the response;
that the at least one requested object did not satisfy the precondition;
that the at least one requested object is not available; and
that all the requested objects are not included with the response.

11. The method of claim 1, wherein the request and response are part of a protocol that provides a specific format for requesting objects to download, for specifying the precondition that applies to the at least one requested object, and for the response.

12. The method of claim 11, wherein the request and response protocol are encoded within a transfer protocol comprising the Hypertext Transfer Protocol (HTTP).

13. The method of claim 1, wherein the response further indicates:
information on the determination of whether precondition was satisfied; and
information on the requested objects included with the response.

14. The method of claim, wherein the available requested objects are transmitted separately from the response.

15. A method for generating a request to download an object from a server over a network, comprising:
generating a request indicating at least one object to download from the server, wherein the request is capable of indicating a plurality of objects to download;
providing at least one precondition with the request that applies to at least one of the objects indicated in the request;
transmitting the request to the server; and
receiving from the server, in response to the request, a response including at least one available requested object if the precondition is satisfied and information indicating results of processing the request.

16. The method of claim 15, wherein the precondition indicates a version of at least one requested object, wherein the at least one requested object satisfies the precondition if the at least one available requested object is the version indicated in the precondition.

17 The method of claim 15, wherein the precondition indicates a maximum object size that applies to all the requested objects, wherein the at least one requested object satisfies the precondition if a cumulative object size is less than the available requested object size.

18. The method of claim 15, wherein the information indicating results of processing the request in the response includes:
information on each requested object that is included in the response;
information on each requested object that is not included in the response.

19. The method of claim 18, wherein the information on each requested object that is not included in the response includes an error code for the at least one requested object indicating a reason for the error.

20. A system for processing a request to download an object from a client computer over a network, comprising:
a storage including a plurality of objects;
means for receiving a request from the client;
means for determining whether at least one object indicated in the request is available for download to the client computer, wherein the request is capable of indicating a plurality of objects to download;
means for determining whether the request indicates at least one precondition that applies to at least one of the objects indicated in the request;
means for determining whether the at least one requested object satisfies the at least one precondition;
means for preparing a response including at least one available requested object from the storage if the at least one precondition is satisfied; and
means for preparing information indicating results of processing the request to return with the response.

22. The system of claim 21, wherein one precondition indicates a version of at least one requested object, wherein the at least one requested object satisfies the precondition if the at least one requested object is the version indicated in the precondition.

23. The system of claim 21, wherein one precondition indicates a maximum object size that applies to all the requested objects, further comprising:
means for determining whether a cumulative object size of the available requested objects exceeds the maximum object size, wherein the at least one available requested object satisfies the precondition if the cumulative object size is less than or equal to the available requested object size.

24. The system of claim 21, wherein the information indicating results of processing the request includes:
information on each requested object that is included in the response;
information on each requested object that is not included in the response.

25. The system of claim 21, wherein the information indicating results of processing the request includes:
information indicating an overall result of processing all the at least one requested object and the precondition.

26. A system for generating a request to download an object from a server over a network, comprising:
means for generating a request indicating at least one object to download from the server, wherein the request is capable of indicating a plurality of objects to download;
means for providing at least one precondition with the request that applies to at least one of the objects indicated in the request;
means for transmitting the request to the server; and
means for receiving from the server, in response to the request, a response including at least one available requested object if the precondition is satisfied and information indicating results of processing the request.

27. The system of claim 26, wherein the precondition indicates a version of at least one requested object, wherein the at least one requested object satisfies the precondition if the at least one available requested object is the version indicated in the precondition.

28 The system of claim 26, wherein the precondition indicates a maximum object size that applies to all the requested objects, wherein the at least one requested object satisfies the precondition if a cumulative object size is less than the available requested object size.

29. The system of claim 26, wherein the information indicating results of processing the request in the response includes:
information on each requested object that is included in the response;
information on each requested object that is not included in the response.

30. An article of manufacture for processing a request to download an object from a client computer over a network, wherein the article of manufacture is capable of causing operations, the operations comprising:
receiving a request from the client;
determining whether at least one object indicated in the request is available for download to the client computer, wherein the request is capable of indicating a plurality of objects to download;
determining whether the request indicates at least one precondition that applies to at least one of the objects indicated in the request;
determining whether the at least one requested object satisfies the at least one precondition;
preparing a response including at least one available requested object if the at least one precondition is satisfied; and
preparing information indicating results of processing the request to return with the response.

31. The article of manufacture of claim 30, wherein one precondition indicates a version of at least one requested object, wherein the at least one requested object satisfies the precondition if the at least one requested object is the version indicated in the precondition.

32. The article of manufacture of claim 31, further comprising:
including a highest version of the at least one available requested object in the response when one precondition does not indicate a version for the at least one requested object.

33. The article of manufacture of claim 30, wherein one precondition indicates a maximum object size that applies to all the requested objects, further comprising:
determining whether a cumulative object size of the available requested objects exceeds the maximum object size, wherein the at least one available requested object satisfies the precondition if the cumulative object size is less than or equal to the available requested object size.

34. The article of manufacture of claim 33, wherein the information indicating results of processing the request includes:
information on the at least one requested object and a size of the at least one requested object when the cumulative object size exceeds the maximum object size.

35. The article of manufacture of claim 30, wherein the information indicating results of processing the request includes:
information on each requested object that is included in the response;
information on each requested object that is not included in the response.

36. The article of manufacture of claim 35, wherein the information on each requested object that is not included in the response includes an error code for the at least one requested object indicating a reason for the error and the precondition that was not satisfied.

37. The article of manufacture of claim 36, wherein the error code is a member of a set of error codes indicating:
that an unexpected error occurred while accessing the requested object;
that the requested object does not exist; and
that the requested object was previously indicated in the request.

38. The article of manufacture of claim 30, wherein the information indicating results of processing the request includes:
information indicating an overall result of processing all the at least one requested object and the precondition.

39. The article of manufacture of claim 38, wherein the information indicating an overall result of processing all the at least one requested object indicates at least one of:
that all the requested objects are included with the response;
that less than all the requested objects are included in the response;
that the at least one requested object did not satisfy the precondition; and
that the at least one requested object is not available.
that all the requested objects are not included with the response.

40. The article of manufacture of claim 30, wherein the request and response are part of a protocol that provides a specific format for requesting objects to download, for specifying the precondition that applies to the at least one requested object, and for the response.

41. The article of manufacture of claim 40, wherein the request and response protocol are encoded within a transfer protocol comprising the Hypertext Transfer Protocol (HTTP).

42. The article of manufacture of claim 30, wherein the response further indicates:
information on the determination of whether precondition was satisfied; and
information on the requested objects included with the response.

43. An article of manufacture for generating a request to download an object from a server over a network, wherein the article of manufacture is capable of causing operations, the operations comprising:
generating a request indicating at least one object to download from the server, wherein the request is capable of indicating a plurality of objects to download;
providing at least one precondition with the request that applies to at least one of the objects indicated in the request;
transmitting the request to the server; and
receiving from the server, in response to the request, a response including at least one available requested object if the precondition is satisfied and information indicating results of processing the request.

44. The article of manufacture of claim 43, wherein the precondition indicates a version of at least one requested object, wherein the at least one requested object satisfies the precondition if the at least one available requested object is the version indicated in the precondition.

45 The article of manufacture of claim 43, wherein the precondition indicates a maximum object size that applies to all the requested objects, wherein the at least one requested object satisfies the precondition if a cumulative object size is less than the available requested object size.

46. The article of manufacture of claim 43, wherein the information indicating results of processing the request in the response includes:
information on each requested object that is included in the response;
information on each requested object that is not included in the response.

47. The article of manufacture of claim 46, wherein the information on each requested object that is not included in the response includes an error code for the at least one requested object indicating a reason for the error.
